(19) United States
(12) Patent Application Publication
(10) Pub. No.: US 2011/0004569 A1
(43) Pub. Date: Jan. 6, 2011

(54) AUTOMATED AND CONSOLIDATED FINANCIAL PLANNING AND SERVICES

(75) Inventor: A. Haag Sherman, Houston, TX (US)

Correspondence Address: CONLEY ROSE, P.C.;David A. Rose, P. O. BOX 3267, HOUSTON, TX, 77253-3267, US

(73) Assignee: SALIENT PARTNERS, L.P., Houston, TX (US)

(21) Appl. No.: 12/918,901

(22) PCT Filed: Feb. 19, 2009
(86) PCT No.: PCT/US09/34490

§ 371 Date: Aug. 23, 2010

Related U.S. Application Data
(60) Provisional application No. 61/031,583, filed on Feb. 26, 2008.

(51) Int. Cl. G06Q 40/00

(52) U.S. Cl. 705/36 R

(57) ABSTRACT

A machine-readable medium has computer-executable instructions, which when executed by a computer, causes the computer to perform a process comprising accepting investor information, determining an investment plan tailored to the investor based on the investor information, implementing the investment plan, and providing regularly updated reports on the investment plan.

### STATEMENT REGARDING FEDERALLY SPONSORED RESEARCH OR DEVELOPMENT

Not applicable.

### BACKGROUND

With the decline of defined benefit plans, investors are increasingly required plan and save for their own retirement. To do so, investors follow one of several models. Some investors prefer to invest on their own by using discount brokerage firms to trade stocks and buy mutual funds (the “self-directed model”). Some investors prefer to rely on financial advisors to invest the investor's assets (the “outsourced model”). Some investors prefer to invest a portion of their assets on their own and rely on financial advisors to invest another portion (the “hybrid model”). Each model has its advantages and disadvantages, and each model will benefit from efficiencies that reduce cost without correspondingly reducing quality of service.

### BRIEF DESCRIPTION OF THE DRAWINGS

For a more complete understanding of the present disclosure, reference is now made to the accompanying drawings and detailed description, wherein like reference numerals represent like parts:

FIG. 1 shows an automated and consolidated financial planning and services system in accordance with at least some illustrative embodiments;

FIG. 2A shows an example of a computer suitable for use as a client workstation or a server in the system accordance with at least some illustrative embodiments;

FIG. 2B shows a block diagram of the computer of FIG. 2A in accordance with at least some illustrative embodiments;

FIG. 3 shows a client-server configuration in accordance with at least some illustrative embodiments; and

FIG. 4 shows a method of implementing automated and consolidated financial planning and services in accordance with at least some illustrative embodiments.

### NOTATION AND NOMENCLATURE

Certain terms are used throughout the following claims and description to refer to particular components. As one skilled in the art will appreciate, different entities may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean an optical, wireless, indirect or direct electrical connection, or other type of direct or indirect connection. Thus, if a first device couples to a second device, that connection may be through a direct electrical connection, through an indirect electrical connection via other devices and connections, through an optical connection, through the Internet, or through a wireless connection. Additionally, the term “system” refers to a collection of two or more components, and may be used to refer to an electronic device.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. The discussion of any embodiment is meant only to be illustrative of that embodiment, and not intended to intimate that the scope of the disclosure, including the claims, is limited to that embodiment.

As mentioned above, each investment model has advantages and disadvantages. The self-directed model has the advantage of lower cost compared to the outsourced model because the investor does not pay for the cost of professional advice and management, but does pay trading costs, e.g., costs and fees associated with investing in mutual funds and exchange-traded funds (“ETFs”). However, potential disadvantages of the self-directed model are lack of discipline, lack of financial knowledge, and lack of diversification.

A disadvantage of the outsourced model is that financial advisors may not follow the policies of their own investment firms and may lack the financial knowledge to outperform broad indices, a primary investment vehicle for the self-directed model. Furthermore, many financial advisors lack the resources to procure asset allocation guidance, a significant determinant of investment returns. Just as significantly, few financial advisors integrate critical aspects of the investor's financial profile into the investment plan created for the investor. Ignored critical aspects include an analysis of insurance needs, estate planning, mortgage debt, and other outstanding debt.

Finally, all three models fail to provide frequent and up-to-date reports to the investor regarding the investor's portfolio. Indeed, market analysis as it affects the portfolio is often omitted. Too often, these critical duties of a financial advisor are performed insufficiently for a volatile market. As such, automated and consolidated financial planning and services are disclosed.

Automated and consolidated financial planning and services provide an investment plan tailored to the investor without the attendant costs of customization. Specifically the investment plan comprises the following when desired: a portfolio matched to the investor's objectives and risk tolerance, an integrated insurance solution, an integrated loan, integrated estate planning, and an integrated communication process. All these services are offered at a cost that is less than the outsourced model, e.g. 1% less cost. The cost savings stem from automating and consolidating the planning and services associated with the various financial activities, and the reduced overhead costs and intermediary fees are passed to the investor. Reduced or eliminated fee takers comprise brokers, financial advisors, insurance brokers, and estate attorneys. Automated and consolidated financial planning and services are accessible to all investors through the Internet, which, in at least one embodiment, comprises an end-to-end platform. For example, each investor may open an account via the Internet, and each investor may download updates on the investor's particular portfolio over the Internet via streaming video of the Chief Investment Officer of the consolidation provider every day. Thus, each investor is offered transparency and accountability regarding the management of the investor's investments. Preferably, the Chief Investment Officer provides each investor with a precise update on the investor's portfolio, the markets as a whole, and the affect of market movements on the portfolio. The customized service allows the investor to avoid the disadvantages of the self-directed model, while the cost savings allows the investor to avoid the disadvantages of the outsourced model.

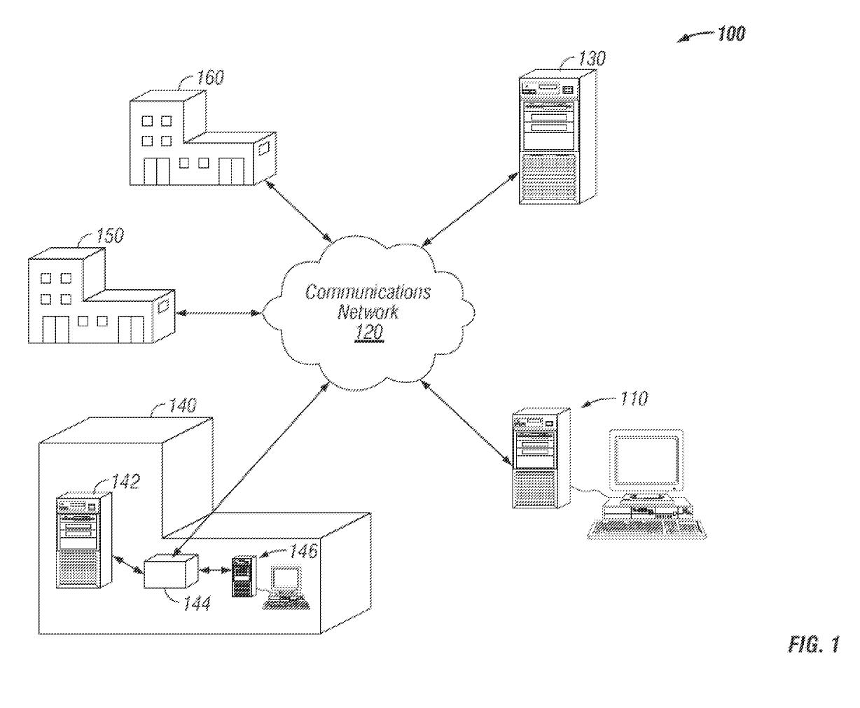

FIG. 1 shows an example system 100 for automated and consolidated financial planning and services. Client workstation 110 is a computer operated by an investor to input investor information into the system 100 and receive output from the system 100. The investor information and output may be generated using hardware and software external to client workstation 110, or may be created using client workstation 110. The investor interacts with the system 100 via client workstation 110, and client workstation 110 couples to server computer 130 via communications network 120 (preferably, the Internet). In at least one embodiment, the server 130 comprises a machine-readable medium storing software that, when executed by a by a computer, causes the computer to perform any of the steps described in this disclosure. In various embodiments, a machine-readable medium comprises volatile memory (e.g., random access memory, etc.), non-volatile storage (e.g., read only memory, Flash memory, hard disk drive, CD ROM, etc.), or combinations thereof.

Software executing on both client workstation 110 and server 130 operate together to process the investor information. The server 130 determines an investment plan for the investor based on the investor information as described more fully below. The server 130 also couples to computer systems operated by multiple financial third parties 140, 150, 160 (e.g., insurers, real estate brokers, investment houses, banks, etc.) via communications network 120, and sends to the financial third parties 140, 150, 160 the portion of the investment plan most relevant to that financial third party 140, 150, 160. In return, the financial third party 140, 150, 160 provides the server 130 with a quotation, which forwarded to workstation 110 if the quotation is selected by the server 130 to be part of an investment plan offered to the investor. In at least one embodiment, the quotation with the lowest bid is selected to be incorporated into the investment plan in order to pass the most savings to the investor.

In the illustrative embodiment shown in FIG. 1, each financial third party 140, 150, 160 couples to communications network 120 via a network interface device (e.g., network hub 144 shown as part of financial third party 140's facilities), which provides connectivity to the financial third party's servers and workstations (e.g., financial third party server 142 and financial third party workstation 146). Although client workstation 110, server 130, and the servers and workstations 142, 146 used by the financial parties 140, 150, 160 are shown coupled to each other through a single network, separate networks may be used to transfer data.

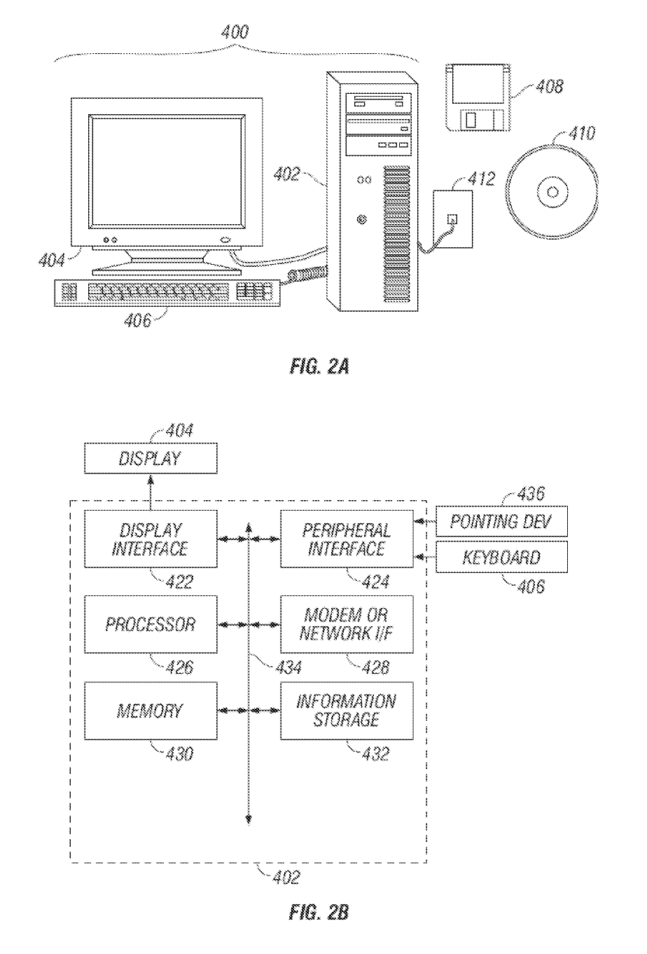

FIGS. 2A and 2B show an illustrative system configuration 400 suitable for implementing client workstation 110, server 130, financial third party server 142, and financial third party workstation 146 of FIG. 1. As shown, the illustrative system configuration 400 includes a chassis 402, a display 404, and an input device 406. The chassis 402 includes a processor 426, memory 430, and information storage device 432. One or more information storage devices 432 may store programs and data on removable storage media such as a floppy disk 408 or an optical disc 410. The chassis 402 also includes a network interface 428 that allows the system 400 to receive information via a network and a wired or wireless wide area network, represented in FIG. 2A by a phone jack 412. The chassis 402 is coupled to the display 404 and the input device 406 to interact with an investor. The display 404 and the input device 406 may together operate as a user interface. The input device 406 is shown as a keyboard, but other input devices such as a mouse or a keypad may also be included.

FIG. 2B shows a simplified functional block diagram of system 400. The chassis 402 may include a display interface 422, a peripheral interface 424, a processor 426, a modem or other suitable network interface 428, a memory 430, an information storage device 432, and a bus 434. System 400 may be a bus-based computer, with the bus 434 interconnecting the other elements and carrying communications between them. The display interface 422 may take the form of a video card or other suitable display interface that accepts information from the bus 434 and transforms it into a form suitable for the display 404. Conversely, the peripheral interface 424 may accept signals from the keyboard 406 and other input devices such as a pointing device 436, and transform them into a form suitable for communication on the bus 434.

The processor 426 gathers information from other system elements, including input data from the peripheral interface 424, and program instructions and other data from the memory 430, the information storage device 432, or from other systems coupled to a local area network or a wide area network via the network interface 428. The processor 426 carries out the program instructions and processes the data accordingly. The program instructions may further configure the processor 426 to send data to other system elements, including investor information and investment plans, which may be communicated via the display interface 422 and the display 404. The network interface 428 enables the processor 426 to communicate with other systems via a local area network or via a wide area network. The memory 430 may serve as a low-latency temporary store of information for the processor 426, and the information storage device 432 may serve as a long term (but higher latency) store of information.

The processor 426, and hence the computer 400 as a whole, operates in accordance with one or more programs stored on a machine-readable medium, e.g. the information storage device 432, or received via the network interface 428. The processor 426 may copy portions of the programs into the memory 430 for faster access, and may switch between programs or carry out additional programs in response to actuation of the input device. The additional programs may be retrieved from the storage device 432 or may be retrieved or received from other locations via the network interface 428. One or more of these programs executes on system 400 causing it to perform at least some of the processing functions disclosed herein.

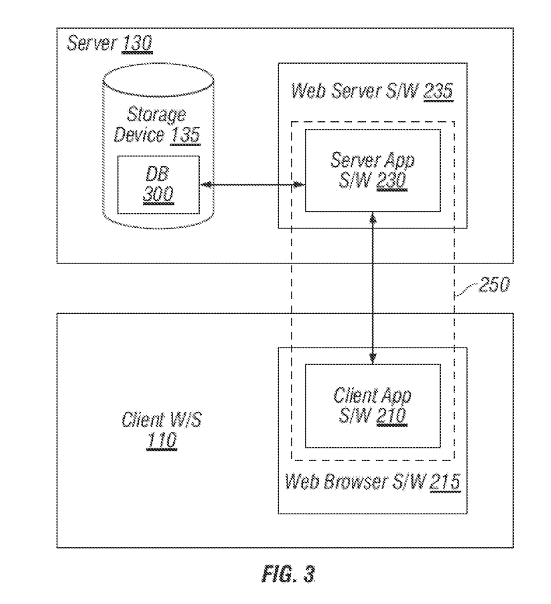

As shown in the illustrative embodiment of FIG. 3, client application software 210 and server application software 230 (executing on client workstation 110 and server 130 respectively) operate in unison as financial processing software 250. The functionality of financial processing software 250 may be distributed between the client and server components in a number of different ways. In at least some illustrative embodiments, most of the data manipulation and processing is concentrated in server application software 230, resulting in a “thin” client implementation of client application software 210, which provides the user interface. Such a thin client may be implemented as a web-based client using the hypertext markup language (“HTML”), Java, or other similar browser-based software. Client application software 210 executes within the environment provided by web browser software 215 (e.g., Microsoft's Internet Explorer, Apple's Safari, or Mozilla's Firefox), which executes on client workstation 110. Client application software 210 communicates and interacts with server application software 230, which executes within the environment created by web server software 235 (e.g., Apache web server software), which in turn executes on server 130.

By using a thin, web-based client and implementing the data processing functions on the server, application specific software does not need to be expressly installed onto client workstation 210. An investor can simply execute web browser software 215 on client workstation 110 and visit a service provider's website, which provides the investor with access to server application software 230 by executing client application software 210 within the web browser. Client application software 210 provides the user interface that allows the investor to input investor information for creation of a data file and uploading of the data file to the server 130. Preferably, the server 130 stores investor information in a database 300 on a storage device 135. In at least some illustrative embodiments, the data file may be created at client workstation 110 using client application software 210. The investor information uses any suitable upload data format. For example, the upload data format may include a file format such as the Adobe portable document format (“PDF”). Some of the upload data formats, such as the PDF upload data format, do not permit individual elements of the investor information to be reformatted. Other upload data formats do permit manipulation and reformatting of individual elements of the investor information. Those skilled in the art will recognize that many other data and file formats may be suitable for describing investor information, and all such data and file formats are intended to be within the scope of the present disclosure.

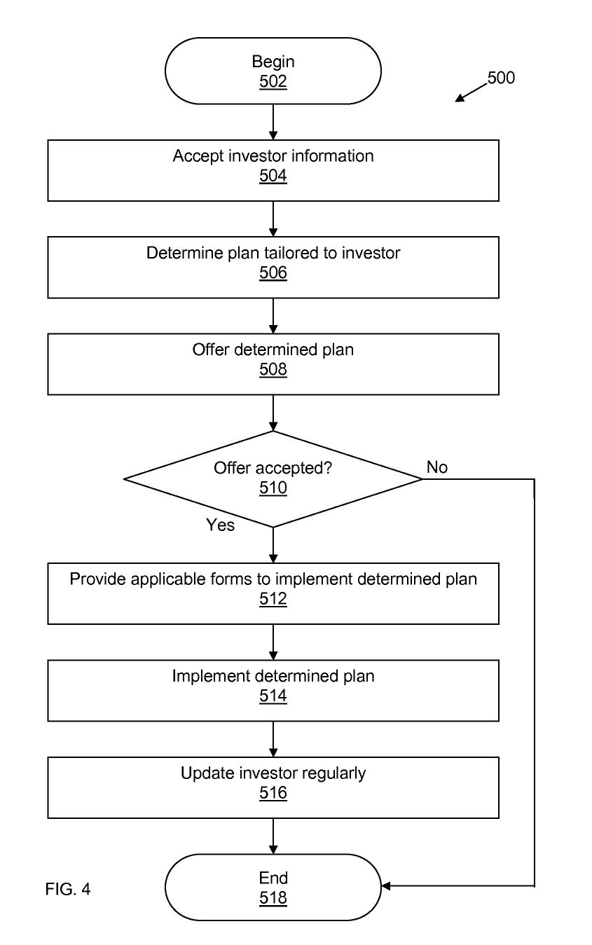

FIG. 4 shows a method 500 of implementing automated and consolidated financial planning and services beginning at 502 and ending at 518. Preferably, the input of investor information, processing, and output of an investment plan is integrated in the same system, e.g. system 100. In at least one embodiment, the input of investor information, processing, and output of an investment plan is completed in less than fifteen minutes, which is a substantial reduction in the amount of time for completion when compared to a non-automated non-consolidated process with the same inputs and outputs. Indeed, the majority of the less than fifteen minutes is used by the investor inputting investor information.

At 504, investor information is accepted. In at least one embodiment, the investor uses workstation 110 to submit investor information over a network 120 to server 130. The investor is prompted for particular investor information via a program or webpage, and particular answers to certain questions preferably lead to follow-up questions. The investor information preferably comprises information related to the investor's finances and financial goals. For example, the investor information comprises any combination of investor's age, desired retirement age, number of dependents, net worth, average income, location of domicile, average monthly outlays, current outside investments, current outside savings, investment objectives, risk tolerance, etc. in at least one embodiment. Preferably, the risk tolerance can be one of three values: low, medium, or high. A low risk tolerance signifies that the investor is willing to forego some investment gains in order to suffer lower investment losses per year, e.g. less than 10%. A medium risk tolerance signifies that the investor wants to generate reasonable growth and is willing to accept annual losses of less than 15% to gain a higher return over time. A high risk tolerance signifies that the investor wants to generate high growth and is willing to accept annual losses of over 20% to gain a higher return over time. Preferably, risk tolerance is automatically set, i.e. the investor does not define the risk tolerance value, based on the investor's current outside savings. For example, a higher value of current outside savings leads to a higher risk tolerance. If the investor is within a threshold number of years to retirement, e.g. 10 years to retirement, the investor's risk tolerance is preferably automatically set to medium. If the investor is within another threshold, e.g. 5 years to retirement, or already retired, the investor's risk tolerance is preferably automatically set to low unless the investor opts out through a specific process that provides a disclaimer of liabilities for reasonably anticipated losses as a result of a more aggressive investment strategy. The threshold numbers are adjustable in at least one embodiment. Preferably, the investor information can be updated at any time to provide the best picture of the investor's current and desired financial profile.

At 506, an investment plan tailored to the investor, i.e. based on the investor information, is determined. Specifically, an investor profile is created based on the investor information, and the investment plan is determined based on how closely the investor profile corresponds with model investor profiles. In at least one embodiment, the investor information is applied to a set of rules and algorithms in order to determine the investment plan and optimize investor needs. Specifically, factors given weight in the algorithms comprise investment merits, cost savings, the impact of the cost savings over time, the investor's risk appetite, age, investment objectives, years to retirement, debt, other holdings, annual savings, etc. The rules and algorithms preferably maximize returns and are updated based on market conditions. In at least one embodiment, the investment plan comprises any combination of insurance, mortgage, and estate planning quotations from the financial third parties 140, 150, 160 and selected by server 130. The investment plan preferably enumerates the level of risk, the current asset allocation, and the change in asset allocation over time. The latter is predicted based on models weighing domestic and foreign economic data such as inflation, interest rates, economic growth, etc.

In at least one embodiment, determining an investment plan comprises selecting a portfolio from among a plurality of portfolios based on the investor information, current economic conditions, prospective economic conditions, current asset class conditions, and prospective asset class conditions. Specifically, in at least one embodiment, one of three portfolios is selected: a growth portfolio, a balanced portfolio, or a conservative portfolio based on the investor information, and each asset class is weighted within the portfolio based on the economic and asset class conditions as well as investor information. Each portfolio preferably invests in exchange-traded funds, indices, mutual funds, or other low cost investment vehicles covering a variety of asset classes. Preferably, the asset classes comprise United States equities, developed country equities, emerging country equities, United States fixed income products, developed country fixed income products, emerging country fixed income products, high yield fixed income products, real estate products, infrastructure products, energy products, etc. Determining an investment plan preferably comprises determining a weight for each asset class from a range of weights for each asset class, the range of weights for each asset class based on the selected portfolio. A sample of the asset allocation for each model is shown in Table 1:

TABLE 1

| | Growth | | Balanced | | Conservative | |
|---|---|---|---|---|---|---|
| Asset Class | Weight | Range | Weight | Range | Weight | Range |
| Equities | 60% | 50% to 70% | 50% | 40% to 70% | 40% | 30% to 60% |
| US | 15% | 10% to 30% | 13% | 10% to 30% | 10% | 10% to 30% |
| Developed | 20% | 10% to 30% | 17% | 10% to 30% | 14% | 10% to 30% |
| Emerging | 25% | 10% to 30% | 20% | 10% to 30% | 16% | 10% to 30% |
| Fixed Income | 20% | 10% to 30% | 30% | 30% to 40% | 40% | 40% to 60% |
| US | 3% | 5% to 10% | 6% | 5% to 15% | 10% | 10% to 35% |
| Developed | 7% | 5% to 10% | 11% | 5% to 15% | 15% | 10% to 35% |
| Emerging | 5% | 5% to 10% | 8% | 5% to 15% | 10% | 10% to 25% |
| High Yield | 5% | 5% to 15% | 5% | 5% to 20% | 7% | 5% to 20% |
| Real Assets | 20% | 10% to 25% | 20% | 10% to 25% | 20% | 10% to 25% |
| Real Estate | 5% | 5% to 15% | 5% | 5% to 15% | 5% | 5% to 15% |
| Infrastructure | 5% | 0% to 10% | 5% | 0% to 10% | 5% | 0% to 10% |
| Energy | 10% | 5% to 15% | 10% | 5% to 15% | 10% | 5% to 15% |

In at least one embodiment, a weight for an asset class is determined outside the range of weights for the asset class if the investor information reflects an investment objective associated with the asset class. As an example, a particular objective may be to hedge another outside equity investment. Therefore, the weight of the fixed income asset class is determined above the range shown. In at least one embodiment, a weight for an asset class is determined outside the range of weights for the asset class if the investor information reflects current outside investments within the asset class above a threshold. For example, the investor information shows over $10,000.00 in outside energy investments. Therefore, the weight of the energy asset class is determined below the range show.

If investor information reflects a need for insurance, e.g. life insurance, follow-up requests include prompts to input spending patterns, debtload, insurance needs, level of health, number of beneficiaries, current life insurance cost, life insurance carrier, assets, debts, spending level, term required, health status, smoker status, etc. Also, the investment plan comprises a life insurance quotation for the investor. In order to determine the proper plan, the server 130 preferably searches through a database of insurers and selects the insurer quotation that can fulfill the investor's needs at the lowest cost based on the investor information. The selected quotation is then incorporated into the investment plan. In at least one embodiment, the profile presupposes that the investor's spouse is the beneficiary of the life insurance. If the spouse is not the beneficiary, and if the amount sought is above the lifetime estate tax exemption, the investor will be encouraged to use an insurance trust in at least one embodiment.

An automobile insurance quotation is provided in a similar matter, e.g., the investor information comprises the investor's current automobile insurance cost, automobile insurance carrier, assets, debts, and spending level, and the quotation is incorporated into the investment plan after the server 130 selects the appropriate quotation at the lowest cost from a database.

If investor information reflects a need for mortgage refinancing, follow-up requests include prompts to input the investor's home value, debt, current mortgage amount, current mortgage payment, current mortgage interest rate, and any future mortgage interest rates. In at least one embodiment, the plan may account for the need to have at least 80% equity in the home by retirement. The investor's profile may also take into account current household expenses, desired savings, balance of net worth to home equity, the investor's creditworthiness, home value, etc. Preferably, the server 130 is provided bids from various financial third parties 140, 150, 160 to incorporate into the plan. In order to determine the proper plan, the server 130 preferably searches through a database of lenders, and the lender quotation that can fulfill the investor's needs at the lowest cost based on the investor information is selected to be incorporated into the plan.

If investor information reflects a need for debt refinancing of other types of debt, follow-up requests include prompts to input the investor's current debt amount, current debt interest rate, any future debt interest rates, etc., and a similar procedure is followed. If investor information reflects a need for estate planning, follow-up requests include prompts to input the investor's domicile location, marital status, parental status, beneficiary elections, specific bequests, residuary beneficiary elections, etc., and a similar procedure is followed. In addition, implementing the investment plan comprises generating a will for the investor based on investor information.

At 508, the determined plan is offered to the investor along with cost of implementing the plan. Preferably, the investment plan comprises the selected portfolio and any of the selected life insurance quotations, automobile insurance quotations, mortgage refinancing quotations, debt refinancing quotations, estate planning quotations, and a will tailored to the investor. In at least one embodiment, the offer comprises a table showing the historical returns of the investment plan along with the value of the cost savings due to reduced advisory costs, discounted quotation costs, and interest costs. The cost may also be compared to the cost of implementing the plan using non-automated and non-consolidated methods such that the investor can readily ascertain the cost savings in the automated and consolidated method.

If the offer is not accepted at 510, the method 500 terminates at 518. If the offer is accepted at 510, the applicable forms to implement the plan are provided to the investor at 512. The applicable forms are preferably sent by the server 130 over the network 120 to the investor at workstation 110. The applicable forms include:
Customer Account Form
Customer Transfer Form (from current customer's brokerage account, if applicable)
Investment Policy (which codifies the asset allocation of the investor)

The investor preferably reviews these forms, electronically signs the forms, and submits the forms. A new account is created by the server 130 and is funded by assets moved from a financial third party 140, 150, 160 brokerage account, a check, or a wire transfer. To the extent that the investor has accepted quotations from financial third parties, the financial third parties are sent relevant investor information for servicing. In at least one embodiment, a financial third party contacts the investor via the system 100 to complete the process.

At 514, the plan is implemented. In at least one embodiment, the investment plan is commonly managed with other investment plans, of other investors, associated with the selected portfolio. Thus, cost savings in the form of reduced transaction fees and reduced fees for investment advice can be passed to the investor, but the investment plan will be rebalanced with sufficient frequency. Once received, the assets are held in cash, and the assets may be invested and liquidated together, e.g. on the first of the month. As such, costs can be driven further down via block trades and allocation. Preferably, implementing the investment plan comprises rebalancing a weight for an asset class if the weight falls out of the range of weights for the asset class. Specifically, a rebalancing sweep, which compares weights of asset classes with respective ranges, occurs at frequent intervals. Each investor's portfolio is professionally managed based on the customized plan offered to the investor. As such, the investor is provided with the advantages of the outsourced model while the financial advisor costs are decreased.

At 516, the investor is updated regularly. An automated communication apparatus provides a consistent message to an investor, is updated daily, and is tailored to the three portfolios with customized additions. For example, the investor may receive a daily update on the investor's portfolio via the Internet. In at least one embodiment, the update will be via video feed posted on a website shortly after the closing of the market. The investor preferably logs into the website with a password to view a video feed of the Chief Investment Officer briefly providing a sense of the current market conditions. Also, the Chief Investment Officer will review performance of the portfolio in which the investor has a stake. Finally, the Chief Investment Officer will review the customized additions that are relevant to the additional services provided to the investor such as the strength of the financial third party firms providing the investor with insurance, loans, housing market, etc. Taken together, the investor's entire plan is reviewed. Although update via video feed is discussed, other methods of updating the investor may be used, such as electronically transferred text information. The investor may also receive statements via email and be able access accounts online. The investor may also receive an annual portfolio overview along with questions designed to ensure that the investment objectives and other investor information has not changed. If investor information has changed, the investor's plan will adjust the plan accordingly. For example, insurance policies will be adjusted to reflect changes in the investor's life such as marriage and the addition of dependents.

Thus, investors are provided with individualized service, and the myriad processes are automated and consolidated. As such, the investor receives better investment services and communication than typically afforded to clients with financial advisors, all at a lower cost.

Other conditions and combinations of conditions will become apparent to those skilled in the art, including the combination of the conditions described above, and all such conditions and combinations are within the scope of the present disclosure. The above disclosure is meant to be illustrative of the principles and various embodiment of the present invention. Numerous variations and modifications will become apparent to those skilled in the art once the above disclosure is fully appreciated. Also, the order of the actions shown in FIG. 4 can be varied from order shown, and two or more of the actions may be performed concurrently. It is intended that the following claims be interpreted to embrace all variations and modifications.

1. A machine-readable medium having computer-executable instructions, which when executed by a computer, cause the computer to perform a process comprising:
accepting investor information;
determining an investment plan tailored to the investor based on the investor information;
implementing the investment plan; and
providing regularly updated reports on the investment plan.

2. The medium of claim 1, wherein determining an investment plan comprises selecting a portfolio from among a plurality of portfolios based on the investor information, current economic conditions, prospective economic conditions, current asset class conditions, and prospective asset class conditions.

3. The medium of claim 2, wherein the asset classes comprise United States equities, developed country equities, emerging country equities, United States fixed income products, developed country fixed income products, emerging country fixed income products, high yield fixed income products, real estate products, infrastructure products, and energy products.

4. The medium of claim 2, wherein implementing the investment plan comprises offering the investment plan to the inventor, the investment plan comprising the selected portfolio and any combination of: life insurance quotations, automobile insurance quotations, mortgage refinancing quotations, debt-refinancing quotations, and estate planning quotations.

5. The medium of claim 2, wherein the plurality of portfolios comprise a growth portfolio, a balanced portfolio, and a conservative portfolio.

6. The medium of claim 5, wherein the investment plan is commonly managed with other investment plans, of other investors, associated with the selected portfolio.

7. The medium of claim 5, wherein determining an investment plan comprises determining a weight for each asset class from a range of weights for each asset class, the range of weights for each asset class based on the selected portfolio.

8. The medium of claim 7, wherein implementing the investment plan comprises rebalancing a weight for an asset class if the weight falls out of the range of weights for the asset class.

9. The medium of claim 7, wherein a weight for an asset class is determined outside the range of weights for the asset class if the investor information reflects an investment objective associated with the asset class or if the investor information reflects current outside investments within the asset class above a threshold.

10. The medium of claim 9, wherein the investment objective comprises hedging an outside equity investment.

11. The medium of claim 1, wherein investor information comprises the investor's age, desired retirement age, number of dependents, net worth, average income, location of domicile, average monthly outlays, current outside investments, current outside savings, investment objectives, and risk tolerance.

12. The medium of claim 11, wherein risk tolerance is automatically set to low, unless the investor opts out, if the difference between the desired retirement age and the age is less than or equal to a threshold value.

13. The medium of claim 11, wherein risk tolerance is automatically set based on the current outside savings, and a higher value of current outside savings leads to a higher risk tolerance.

14. A method, comprising:
accepting investor information via a client computer;
determining an investment plan tailored to the investor based on the investor information via a server computer;
implementing the investment plan via the server computer; and
providing regularly updated reports on the investment plan to the client computer;
wherein determining an investment plan comprises selecting a portfolio from among a plurality of portfolios based on the investor information, current economic conditions, prospective economic conditions, current asset class conditions, and prospective asset class conditions.

15. The method of claim 14, wherein the plurality of portfolios comprise a growth portfolio, a balanced portfolio, and a conservative portfolio, and wherein the investment plan is commonly managed with other investment plans, of other investors, associated with the selected portfolio.

16. The method of claim 15, wherein determining an investment plan comprises determining a weight for each of a plurality of asset classes from a range of weights for each asset class, the range of weights for each asset class based on the selected portfolio.

17. The method of claim 16, wherein a weight for an asset class is determined outside the range of weights for the asset class if the investor information reflects an investment objective associated with the asset class or if the investor information reflects current outside investments within the asset class above a threshold.

18. The method of claim 16, wherein implementing the investment plan comprises rebalancing a weight for an asset class if the weight falls out of the range of weights for the asset class.

19. A system, comprising:
a server computer;
a client computer coupled to the server computer; and
instructions stored on the server computer that, when executed on the server computer, perform a method comprising:
accepting investor information;
determining an investment plan tailored to the investor;
implementing the investment plan; and
providing regularly updated reports on the investment plan;
wherein determining an investment plan comprises selecting a portfolio from among a plurality of portfolios based on the investor information, current economic conditions, prospective economic conditions, current asset class conditions, and prospective asset class conditions.

20. The system of claim 19, wherein determining an investment plan comprises determining a weight for each of a plurality of asset classes from a range of weights for each asset class, the range of weights for each asset class based on the selected portfolio, and wherein a weight for an asset class is determined outside the range of weights for the asset class if the investor information reflects an investment objective associated with the asset class or if the investor information reflects current outside investments within the asset class above a threshold.
